(19) United States
(12) Patent Application Publication
(10) Pub. No.: US 2012/0042243 A1
(43) Pub. Date: Feb. 16, 2012

(54) ELECTRONIC SYSTEM AND CONTROLLING METHOD THEREOF

(75) Inventor: Su-Cheng Liu, Hsinchu City (TW)

(73) Assignee: E Ink Holdings Inc., Hsinchu (TW)

(21) Appl. No.: 12/908,334

(22) Filed: Oct. 20, 2010

(30) Foreign Application Priority Data
Aug. 13, 2010 (TW) 099127212

(51) Int. Cl. G06F 17/00

(52) U.S. Cl. 715/273

(57) ABSTRACT

An electronic system comprises an electronic processing device and a reading device having a display screen. When the electronic processing device is connected to the reading device through a data-transmitting interface, the electronic processing device transmits an electronic file in the electronic processing device to the reading device by a predetermined mode, such that the reading device displays images of the electronic file on the display screen according to a predetermined specification.

### FIELD OF THE INVENTION

The present invention relates to an electronic system, and more particularly to an electronic system configured for reading an electronic file.

### BACKGROUND OF THE INVENTION

With the rapid development of the technology, the electronic processing device with the operation processing function, such as the personal computer, the large computer, the personal digital assistant, the pocket computer, the mobile phone or the smart phone, etc., has been widely applied into the daily work and life of the human, and has been an important tool for the work, study and entertainment of the human.

For the large-size electronic processing device, such as the personal computer or the large computer etc., it is difficult to move. Thus after the user completes processing various electronic files on the personal computer or the large computer, it generally needs printing the electronic files such that the user can employ the paper files for reporting to the leader or the client. Therefore, it will largely consume the papers, waste the resource, and non-conform the green and environment friend trend with the paperless work.

For the small-size portable electronic processing device, such as the personal digital assistant, the pocket computer, the mobile phone or the smart phone etc., although they are prone to move and display the electronic files on the display screen of the small-size portable electronic processing device, the display screen of the small-size portable electronic processing device is generally small. Thus, the images of the electronic files displayed on the display screen of the small-size portable electronic processing device are small, and it is difficult to read for the user.

### SUMMARY OF THE INVENTION

Therefore, the object of the present invention is to provide an electronic system, which can save papers, confirm the green environment friend trend with paperless work, and be read by a comfortable mode.

The object of the present invention is also to provide a controlling method of an electronic system, which can save papers, confirm the green environment friend trend with paperless work, and be read by a comfortable mode.

The present invention provides an electronic system, comprises an electronic processing device and a reading device having a display screen. When the electronic processing device is connected to the reading device through a data-transmitting interface, the electronic processing device transmits an electronic file in the electronic processing device to the reading device by a predetermined mode, such that the reading device displays images of the electronic file on the display screen according to a predetermined specification.

In an exemplary embodiment of the present invention, the electronic processing device is an electronic device with an operation processing function. Preferably, the electronic processing device is selected from a group consisted of a personal computer, a large computer, a personal digital assistant, a pocket computer, a mobile phone and a smart phone.

In an exemplary embodiment of the present invention, the reading device further comprises a storing unit configured for storing the images of the electronic file. In addition, the reading device further comprises an operation module having a plurality of function keys, and each of the function keys corresponds to a different operation function respectively.

In an exemplary embodiment of the present invention, the reading device is a portable device, such as an e-book reader, and the predetermined specification is a pdf type or an epub type.

In an exemplary embodiment of the present invention, the predetermined mode is a dummy printing mode, and the electronic processing device transmits the electronic file to the reading device by the dummy printing mode.

In an exemplary embodiment of the present invention, the display screen is a bistable display screen, such as an electrophoretic display screen.

In an exemplary embodiment of the present invention, the data-transmitting interface is a universal serial bus (USB) interface or a wireless fidelity (WiFi) interface.

In an exemplary embodiment of the present invention, the electronic file is selected from a group consisted of an e-book, a word file, an image file and an email file.

The present invention also provides a controlling method of an electronic system. The electronic system comprises an electronic processing device and a reading device having a display screen. The controlling method comprises: detecting whether the reading device is connected to the electronic processing device through a data-transmitting interface; and transmitting an electronic file in the electronic processing device to the reading device by a predetermined mode such that the reading device displays images of the electronic file on the display screen according to a predetermined specification, when the reading device is connected to the electronic processing device through the data-transmitting interface.

In an exemplary embodiment of the present invention, the predetermined mode is a dummy printing mode, and the electronic processing device transmits the electronic file to the reading device by the dummy printing mode.

In an exemplary embodiment of the present invention, the reading device is an e-book reader, and the reading device displays the images of the electronic file on the display screen according to a pdf type or an epub type.

The electronic system and the controlling method of the present invention can transmit the electronic file in the electronic processing device to the reading device by the predetermined mode, such that the reading device can display the images of the electronic file. Therefore, the electronic file in the electronic processing device does not need to be printed into the papers, the electronic system of the present invention will not consume the papers, not waste the resource, and confirm the green environment friend trend with the paperless work. In addition, since the size of the display screen of the reading device is large, such as 10 inches, the user can comfortably read the images of the electronic file.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block schematic view of an electronic system in accordance with an exemplary embodiment of the present invention.

FIG. 2 is a schematic view of function keys of an operation module as shown in FIG. 1.

FIG. 3 is a flow chart of a controlling method of an electronic system in accordance with an exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

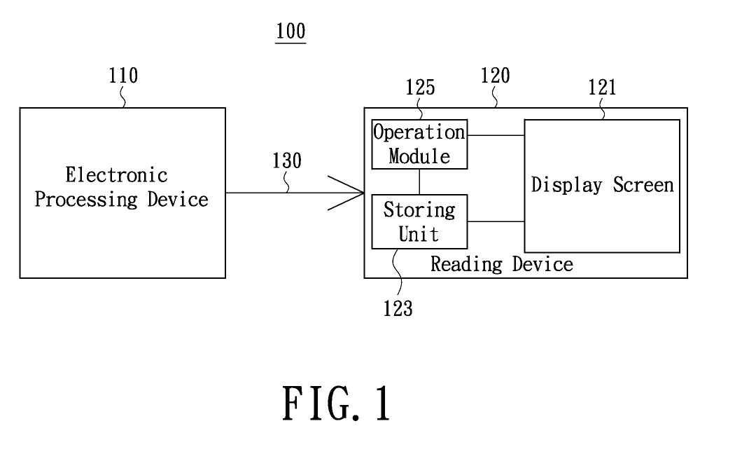

FIG. 1 is a block schematic view of an electronic system in accordance with an exemplary embodiment of the present invention. Referring to FIG. 1, the electronic system 100 of the exemplary embodiment comprises an electronic processing device 110 and a reading device 120. The electronic processing device 110 may be an electronic device with operation processing function, such as a personal computer, a large computer, a personal digital assistant, a pocket computer, a mobile phone or a smart phone. The reading device 120 may be a portable electronic device, such as a common e-book reader, which comprises a display screen 121. Preferably, the display screen 121 may be a bistable display screen, such as an electrophoretic display screen.

Furthermore, the electronic processing device 110 is connected to the reading device through a data-transmitting interface 130. Preferably, the data-transmitting interface 130 may be a wire interface, such as a universal serial bus (USB). Alternatively, the data-transmitting interface 130 also may be a wireless interface, such as an wireless fidelity (WiFi).

When the electronic processing device 110 is connected to the reading device 120 through the data-transmitting interface 130, the electronic processing device 110 transmits an electronic file therein to the reading device 120 by a predetermined mode according to an operation of an user, such that the reading device 120 can displays images of the electronic file on the display screen 121 of the reading device 120 according to a predetermined specification.

In detail, since the reading device 120 is the e-book reader which only display images of an electronic file with a pdf type or an epub type, and the electronic file of the electronic processing device 110 may be an e-book, a word file, an image file or an email file, a dummy printing driver is installed in the electronic processing device 110 of the present invention. Thus the user can employ the dummy printing driver to print the electronic file of the electronic processing device 110 to convert the electronic file of the electronic processing device 110 into the electronic file with the predetermined specification, such as the pdf type or the epub type, and transmit it to the reading device 120, such that the reading device 120 can display the images of the electronic file with the predetermined specification, such as the pdf type or the epub type. Of course, it is understood for persons skilled in the art that, the electronic processing device 110 also may employ other predetermined modes to convert the electronic file therein into the electronic file with the predetermined specification which is suited for the reading device 120, and transmit it to the reading device 120. In addition, it is understood for persons skilled in the art that, the reading device 120 may be an independent electronic device, which still can independently display the images of the transmitted electronic file when it is not connected to the electronic processing device 110.

In addition, continuing referring to FIG. 1, the reading device 120 may further comprises a storing unit 123 and an operation module 125. The storing unit 123 may be configured for storing the images of the electronic file transmitted from the electronic processing device 110, and it may be a volatile memory, such as a flash memory. Of course, the storing unit 123 also may be a hard disk. In some preferable exemplary embodiments, the storing unit 123 also may be a memory card.

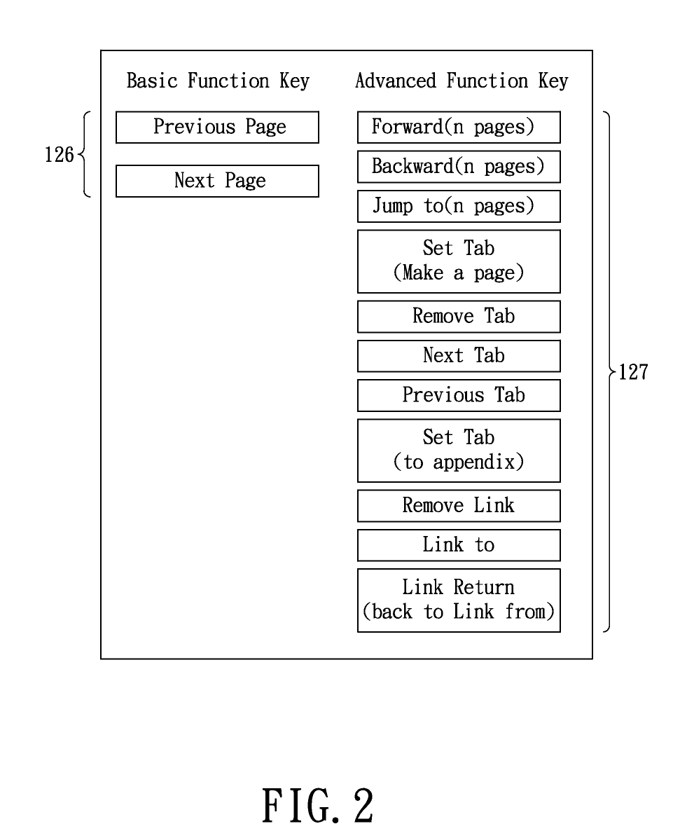

The operation module 125 comprises a plurality of function keys for performing related operations for the images of the electronic file displayed on the display screen 121. The function keys may be touch keys or actual mechanical keys, and each of the function keys correspond to a different operation function respectively. Refer to FIG. 2, which is a schematic view of the function keys of the operation module. As shown in FIG. 2, the function keys may be divided into basic function keys 126 and advanced function keys 127. The basic function keys 126 mainly correspond to some basic operation functions, such as Next Page, Previous Page etc. The advanced function keys 127 mainly correspond to some advanced operation functions, such as Forward (n pages), Backward (n pages), Jump to (n-th page), Set Tab (Mark a page), Remove Tab, Next Tab, Previous Tab, Set Link (to appendix), Remove Link, Link to, Link Return (back to Link from), etc. The user can operate the function keys to make the reading device 120 perform the corresponding operation functions.

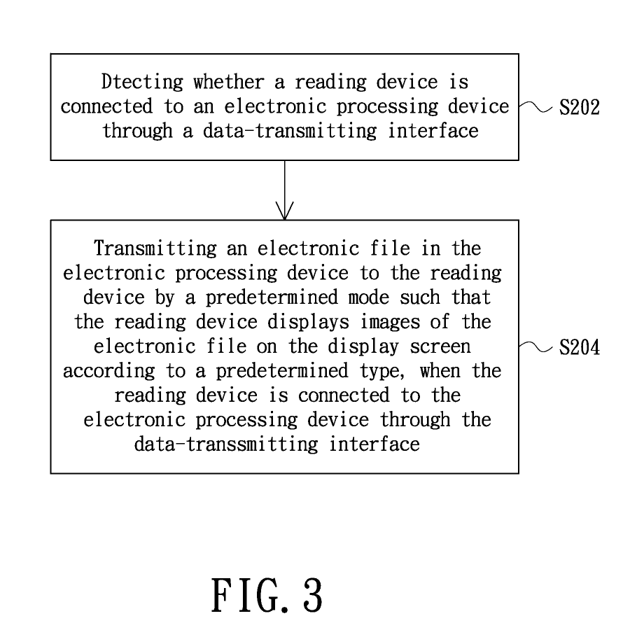

The present invention also provides to a controlling method of an electronic system, which is adapted into the electronic system 100 as shown in FIG. 1. FIG. 3 is a flow chart of a controlling method of an electronic system in accordance with an exemplary embodiment of the present invention. Referring to FIG. 3, the controlling method of the exemplary embodiment comprises: detecting whether the reading device 120 is connected to the electronic processing device 110 through the data-transmitting interface 130; employing a predetermined mode to transmit an electronic file in the electronic processing device 110 to the reading device 120 such that the reading device 120 can display the images of the electronic file on the display screen 121 according to a predetermined specification. Preferably, the electronic processing device 110 employs the dummy printing mode to transmit the electronic file to the reading device 120. The reading device 120 is the e-book reader, and displays the images of the electronic file on the display screen 121 according to the pdf type or the epub type.

In summary, the electronic system and the controlling method of the present invention can transmit the electronic file in the electronic processing device 110 to the reading device 120 according to the predetermined mode, such that the reading device 120 can display the images of the electronic file. Therefore, the electronic file in the electronic processing device 110 does not need to be printed into the papers, the electronic system of the present invention will not consume the papers, not waste the resource, and confirm the green environment friend trend with the paperless work. In addition, since the size of the display screen 121 of the reading device 120 is large, such as 10 inches, the user can comfortably read the images of the electronic file.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic system, comprising:
an electronic processing device; and
a reading device comprising a display screen;
wherein when the electronic processing device is connected to the reading device through a data-transmitting interface, the electronic processing device transmits an electronic file in the electronic processing device to the reading device by a predetermined mode, such that the reading device displays images of the electronic file on the display screen according to a predetermined specification.

2. The electronic system according to claim 1, wherein the electronic processing device is an electronic device with an operation processing function.

3. The electronic system according to claim 2, wherein the electronic processing device is selected from a group consisted of a personal computer, a large computer, a personal digital assistant, a pocket computer, a mobile phone and a smart phone.

4. The electronic system according to claim 1, wherein the reading device further comprises a storing unit configured for storing the images of the electronic file.

5. The electronic system according to claim 1, wherein the reading device further comprises an operation module having a plurality of function keys, and each of the function keys corresponds to a different operation function respectively.

6. The electronic system according to claim 1, wherein the reading device is a portable device.

7. The electronic system according to claim 6, wherein the reading device is an e-book reader.

8. The electronic system according to claim 1, wherein the predetermined specification is a pdf type or an epub type.

9. The electronic system according to claim 1, wherein the predetermined mode is a dummy printing mode, and the electronic processing device transmits the electronic file to the reading device by the dummy printing mode.

10. The electronic system according to claim 1, wherein the display screen is a bistable display screen.

11. The electronic system according to claim 10, wherein the display screen is an electrophoretic display screen.

12. The electronic system according to claim 1, wherein the data-transmitting interface is a universal serial bus (USB) interface or a wireless fidelity (WiFi) interface.

13. The electronic system according to claim 1, wherein the electronic file is selected from a group consisted of an e-book, a word file, an image file and an email file.

14. A controlling method of an electronic system, the electronic system comprising an electronic processing device and a reading device having a display screen, the controlling method comprising:
detecting whether the reading device is connected to the electronic processing device through a data-transmitting interface; and
transmitting an electronic file in the electronic processing device to the reading device by a predetermined mode such that the reading device displays images of the electronic file on the display screen according to a predetermined specification, when the reading device is connected to the electronic processing device through the data-transmitting interface.

15. The controlling method according to claim 14, wherein the predetermined mode is a dummy printing mode, and the electronic processing device transmits the electronic file to the reading device by the dummy printing mode.
